(19) United States
(12) Patent Application Publication
(10) Pub. No.: US 2022/0174929 A1
(43) Pub. Date: Jun. 9, 2022

(54) MOSQUITO CONTROL

(71) Applicant: Brandenburg Innovation Limited, Brierley Hill (GB)

(72) Inventor: Ambika Rao, Brierley Hill (GB)

(21) Appl. No.: 17/440,740

(22) PCT Filed: Mar. 18, 2020
(86) PCT No.: PCT/IB2020/052467

§ 371 Date: Sep. 17, 2021

(30) Foreign Application Priority Data
Mar. 18, 2019 (GB) 1903658.1

(51) Int. Cl. A01M 1/10; A01N 63/10; A01M 1/20

(52) U.S. Cl. CPC A01M 1/106; A01M 1/20; A01N 63/10

(57) ABSTRACT

A method of controlling mosquito populations is disclosed. The method includes: placing a plurality of ovitraps into an area where it is desired to reduce a mosquito population; filling the ovitraps with water; introducing a defined larvicidal amount of a water conditioning agent comprising cow urine into a given volume of water into the ovitraps to condition the water absent of a separate or additional pesticide; leaving the conditioned water for at least 7 weeks; and monitoring at least one of the ovitrap and the area to determine effectiveness.

### CROSS-REFERENCE TO RELATED APPLICATION

This application claims priority to International Patent Application No. PCT/IB2020/052467 filed Mar. 18, 2020, which claims priority to Great Britain Patent Application GB 1903658.1, Mar. 18, 2019, the contents of each of which is hereby incorporated by reference in its entirety.

### TECHNICAL FILED

This invention relates to a product, method, and use of cow urine for the control of mosquito populations. The term cow urine, as used herein, includes products derived from cow urine including liquid concentrates and solid forms e.g. powders or tablets, more preferably presented in a unit dosage form, for ease of use. The product may additionally include instructions for dosing at given concentrations.

### BACKGROUND

The prior art, as exemplified by Applicants own international patent application PCT/IB2018/000965, teaches Ovitraps, which use attractants e.g. chemicals providing ovipositor cues to attract insects and a separate means e.g. pesticides, including larvicides and adulticides, or mechanical means for killing the mosquitos and/or their larvae.

Mosquitos are vectors for many diseases, such as, but not limited to, for example, malaria, dengue fever, chicken guinea, filariasis, yellow fever, Japanese encephalitis, and Zika virus and thus, for effective control, the efficacy of the traps and associated methodology needs to be high.

Indeed, current mosquito control programmes around the world face challenges resulting from the large number of mosquito species, the diversity of their habitats and contact with humans.

The vector control strategies seek to bring about behaviour modification of gravid females, and interfere with development of egg, larvae and pupae, thereby resulting in population reduction. The use of ovitraps and pesticides are thus becoming common place.

There are around 3,500 species of mosquitos belonging to 43 genera which fall into two main subfamilies, the Anophelinae and Culicinae.

The distinction is of great practical importance because the two subfamilies tend to differ in their significance as vectors of different classes of diseases.

Human malaria is transmitted only by females of the genus Anopheles.

On the other hand, arboviral, such as yellow fever and dengue fever, tend to be transmitted by Culicine species, primarily, though not necessarily of the genus Culex.

Two main groupings within the genus Anopheles are one formed by Cellia and Anopheles subgenera, and the other by Kerteszia, Lophopodomyia and Nyssorhynchus.

The primary species known to carry human malaria lie within the Anopheles sub genera.

The subfamily Culicinae has 3,046 species in 108 genera that are sorted into 11 tribes, namely:
Aedeomyiini;
Aedini (including Aedes sp);
Culicini (including Culex sp);
Culisetini;
Ficalbiini;
Hodgesiini;
Mansoniini;
Orthopodomyiini;
Sabethini;
Toxorhynchitini; and
Uranotaeniini.

International Journal of Pharmacy and Pharmaceutical Science Vol 6, Issue 3, 2014, pages 20-22 discusses the diversified uses of cow urine and states cow urine to be an ovipositor cue to Anopheles gambiae and Culex quinquefasciatus.

Separately it also states it is a biopesticide and bio-enhancer in agricultural operations.

Other documents disclose the use attractants include:

EA 026601 which discloses an aerosol containing attractants;

Hawaria, Dawat et al J Infect Dev Ctries, 2016, 10 (1), 082-089 which used textile strip soaked in cow urine as an attractant;

Kweka et al, Parasites & Vectors, 2011, 4, 184 which looked at the effect of cow urine (fresh and aged) on ovipositioning by filling basins whose sides were lined with paper with soil, water and cow urine. These would not be considered ovitraps;

Kweka et al, Parasites & Vectors, 2010, 3, 75 which looked at odour based resting boxes for sampling mosquitos;

Mahande A M et al, BMC Infect Dis, 2010 Jun. 15, 10, 172 which also used urine soaked cloth on baiting boxes; and

Kweka et al, Malaria Journal, 2009, 8 82 which also used urine soaked cloth on baiting boxes.

Most significantly, it has not however previously been recognised that cow urine acts both as a mosquito attractant and (very significantly) a mosquito larvicide making it useful as a natural product for mosquito management independent of additional pesticides.

It is an object of the present invention to provide simpler, more efficacious ovitraps and population control methodology for use therewith. The fact that the cow urine acts as a larvicide enables it to be dosed into the water of ovitraps, in amounts that are larvicidal, as opposed to being, for example, soaked into a cloth to merely attract mosquitos to an area.

### SUMMARY

In accordance with a first aspect of the present invention there is provided an ovitrap comprising a receptacle, which in use is filled with water, an ovipositing surface upon which mosquitos settle to deposit eggs into the water, characterised in that the ovitrap in use, includes a water conditioning agent that is also larvicidal, such that the trap is absent of any additional pesticide.

Preferably the ovitrap is dosed with, as a water conditioning agent and larvicide, cow urine. Thus, the ovitrap may be provided as a kit, together with cow urine in a unit dosage form, and/or with instructions advising on its use with cow urine, and appropriate dosing levels thereof with the ovitrap.

Preferably, though not essentially, the cow urine is derived from Bos indicus, Bos Taurus or Zebu cattle.

The composition of cow urine typically comprises, other than water, 40-60% by weight urea, and 40-60% by weight, other components including: minerals, salt, hormones and enzymes. See, for example, International Journal of Res Ayurveda pharm 8 [5], 2017, pages 1-6, incorporated by reference.

A biochemical analysis of the cow urine has shown the other components to include, elements including sodium, calcium, nitrogen, sulphur, manganese, iron, silicon, chlorine, phosphorous and magnesium, alone or as minerals or salts, vitamins, acids, such as, citric, uric, and carbolic, and as well as sugars e.g. lactose, protein and creatine.

The presence of particularly: urea, creatine, aurum hydroxide, carbolic acid, phenols, calcium and magnesium, it has been suggested, contribute to the cow urines antimicrobial properties.

The enzymes include proteases, chitinases, and lipases which act on the mosquito larvae.

Additionally, microbes present in the cow urine and/or attracted to the conditioned water assist in the process. This is outlined in FIG. 1.

Preferably the cow urine is provided in a unit dosage form.

The unit dosage form may be a powder, granules, a tablet or a liquid with a measuring dispenser.

Applicant further analysed a number of different cow urine forms for the phenol, flavonoids and amino acid content The results are given in Tables 1 and 2 below:

TABLE 1

| Sl. No. | Sample Name | Powder | Liquid | Tablet form |
|---|---|---|---|---|
| 1 | Total Phenol (mg Gallic | R1-69.41, | R1-290.03 | R1-1002.84 |
| | Acid Equiv/100 gm) | R2-84.46 | R2-407.01 | R2-1041.81 |
| 2 | Total Flavonoids (mg | R1-0.04 | R1-0.09 | R1-0.37 |
| | Catechin Equiv/100 gm) | R2-0.07 | R2-0.04 | R2-0.41 |

TABLE 2

| | Powder R1 | Powder R2 | Sol R1 | Sol R2 | Tab R1 | Tab R2 |
|---|---|---|---|---|---|---|
| Amino Acids | mg/gram | mg/gram | mg/ml | mg/ml | mg/gram | mg/gram |
| Glycine | 9.790 | 14.684 | 9.629 | 7.363 | 14.962 | 21.017 |
| alanine | 2.521 | 2.521 | 7.169 | 5.446 | 9.523 | 9.419 |
| serine | 11.386 | 13.663 | 21.646 | 24.359 | 55.450 | 38.648 |
| proline | 11.533 | 8.210 | 6.348 | 5.629 | 51.359 | 64.251 |
| valine | 3.417 | 1.665 | 1.561 | 2.650 | 12.659 | 14.357 |
| threonine | 2.468 | 2.468 | 1.777 | 1.777 | 6.950 | 4.387 |
| cysteine | 7.359 | 8.806 | 12.266 | 8.133 | 17.945 | 22.431 |
| leucine | 15.356 | 13.090 | 4.108 | 3.537 | 48.678 | 51.558 |
| asparagine | 63.602 | 59.059 | 60.104 | 43.125 | 91.003 | 118.032 |
| aspertic acid | 35.950 | 28.512 | 14.727 | 9.372 | 121.541 | 111.148 |
| lysine | 2.371 | 4.268 | 8.571 | 5.876 | 7.115 | 9.663 |
| glutamic acid | 9.221 | 5.928 | 7.113 | 4.979 | 39.642 | 31.548 |
| methionine | 11.430 | 11.430 | 7.002 | 9.321 | 41.359 | 46.987 |
| Histidine | 6.046 | 9.068 | 3.265 | 2.176 | 7.186 | 4.106 |
| Ethionine | 1.544 | 1.802 | 0.417 | 0.417 | 1.311 | 1.311 |
| phenyl alanine | 13.369 | 13.295 | 3.191 | 2.473 | 49.231 | 32.564 |
| Arginine | 10.603 | 19.615 | 6.298 | 4.580 | 13.964 | 15.656 |
| Citrulline | 51.235 | 65.214 | 24.687 | 18.254 | 57.219 | 84.312 |
| Tyrosine | 30.909 | 29.566 | 1.935 | 3.387 | 88.235 | 72.316 |
| beta-3,4-Dihydroxy | 2.882 | 1.441 | 1.297 | 1.037 | 1.957 | 1.957 |
| phenyl alanine | | | | | | |
| Tryptophan | 3.310 | 3.783 | 0.894 | 0.766 | 1.723 | 1.204 |

Whist there appear some significant variation between the different forms three amino acids appeared to be of particular significance, namely asparagine, aspartic acid, and citrulline. These are present in significant levels compared to the total amino acid content.

In accordance with a second aspect of the present invention there is provided a method of controlling mosquito populations comprising:
Placing a plurality of ovitraps into an area where it is desired to reduce the mosquito population;
Filling the ovitraps with water;
Introducing a defined larvicidal amount of cow urine, into a given volume of water into the ovitraps to condition the water absent of a separate or additional pesticide; and
Monitoring the ovitraps and/or area to determine effectiveness.

Preferably the mosquito population targeted is one of either sub-families, the Anophelinae and Culicinae.

The Culicinae is preferably an Aedini, more preferably an Aedes sp or a Culicini, more preferably a Culex sp.

In accordance with a variation to the second aspect of the present invention there is provided a method of controlling mosquito populations comprising:
Identifying a source of water in an area where it is desired to reduce the mosquito population;
Introducing a defined larvicidal amount of a water conditioning agent comprising cow urine, into a given volume of water, absent of a separate or additional pesticide; and
Monitoring the water and/or area to determine effectiveness.

The source of water in an area may include any relatively small article or feature that retains water, for example, a pond, open water tank, or guttering around a house.

Preferably the methods comprise one or more of monitoring adult mosquito numbers, monitoring the number of eggs deposited, and/or determining the number of dead larvae.

Preferably the method deploys a plurality of ovitraps in area where it is desired to reduce the mosquito population.

According to a third aspect of the present invention there is provided cow urine for use as a larvicide in population control against mosquitos of the genus Anopheles or Calicine.

The cow urine can be used in a method of controlling the spread of diseases, such as, for example, malaria and arboviral diseases, such as, but not limited to for example, dengue fever.

### BRIEF DESCRIPTION OF THE DRAWINGS

Embodiments of the invention are further described hereinafter with reference to the accompanying drawings, in which:

FIG. 1 is a, non-limiting, flow diagram indicative of the larvicidal process,

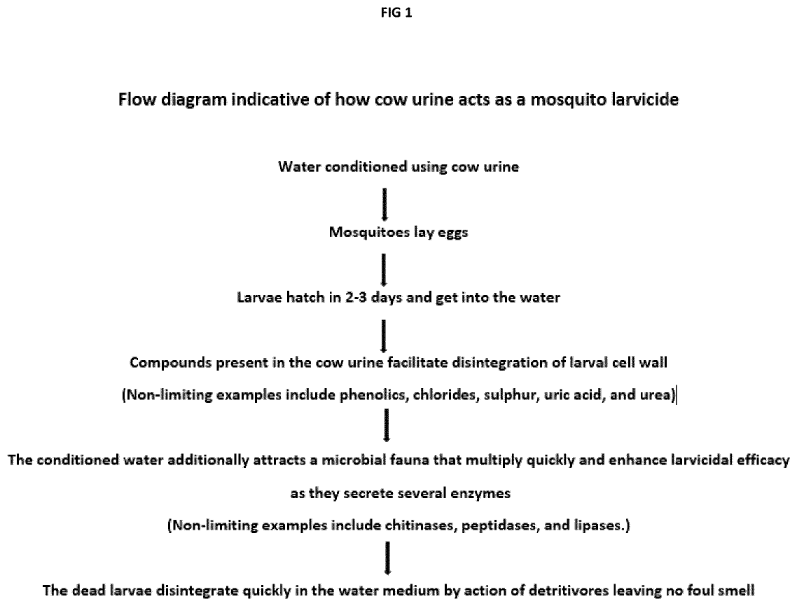

FIG. 2 is a graph showing eggs laid at a first location;

FIG. 3 is a graph showing OPI (Ovitrap Positivity Index) and EDI (Egg Density Index) at a first location;

FIG. 4 is a graph showing eggs laid at a second location; and

FIG. 5 is a graph showing OPI and EDI at a second location.

### DETAILED DESCRIPTION

The cow urine was tested in two field experiments as set out below:

### Field Testing of Ovitraps:

Field trials were conducted using 2 concentrations of a liquid and solid (re-dissolved) cow urine, as per the treatment details below:

### Treatment Details:

T1: Bioactive 1—CU (Cow Urine)—10%, 15% (vol/vol)

T2: Bioactive 2—Tablet (Cow Urine concentrate tablet)—10%, 15% (weight/vol)

Control: Water

### Test Locations:

Two different test locations were used.

Location 1 was a 40-acre area including a school, hostel, health centre, human dwellings, cattle sheds and open water tanks with likely mosquito breeding. Twenty-six ovitraps with different treatment concentrations and control water were randomly placed across the location, spread across >3000 m² area.

Location 2 was a 30-acre area, characterised by villas, restaurants and hotel accommodation interspersed with wild vegetation that comprise shrubs, trees and large open grass lands. Twenty ovitraps with different treatment concentrations and control water were randomly placed across Location 2, spread across >2000 m² area.

In both of the test locations the traps were randomly distributed by generating random numbers in the respective area, complying to randomised complete block design (RCBD statistical design).

### Observations:

Paper strips placed in ovitraps for egg detection were changed once every week. The strips were brought to the laboratory and the number of eggs were counted per strip under a stereo-binocular microscope.

Immature larvae of >2 instar, if any found in traps, were brought in a vial and used for identification, up to species level.

### Results:

### Location 1:

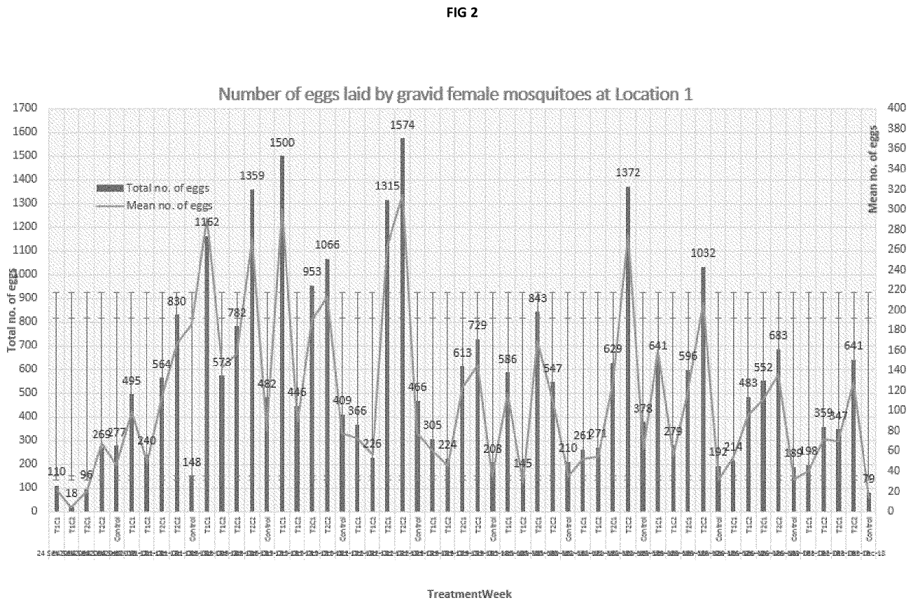

The results are illustrated in FIG. 2.

They show there was egg laying in all treatments and all traps right from the 1^{st} week of the study.

In both treatments (T1 and T2), the total number of eggs and mean number of eggs was 2-3-fold higher compared to control. Both the total and mean number of eggs per trap increased with time in treatments and was lowest in the control. Total and mean numbers of eggs in control traps was lowest at 11 weeks. Always, mean number of eggs laid in control traps ranged between 200-450. Mean number of eggs was as high and >600 in T2 at a concentration of both 10% and 15%. The number of eggs laid in T2 was highest even on 11^{th} week of the field test (>600). Both the treatments were more attractive to the gravid female mosquitoes compared to control traps all through the study. Total and mean number of eggs laid per trap traced an increasing trend in treatments especially in T2 on 11^{th} week as well, at both the concentrations. Aedes aegypti and Aedes albopictus mosquitoes were reported from first week in all the traps. Armigera sp. were attracted for oviposition from 3^{rd} week onwards. From 7^{th} week onwards, Culex quinquefasciatus also was attracted for oviposition.

On the 11^{th} week, the contents in all traps were replaced with fresh solutions, for all treatments including controls. By 11^{th} week, gravid females of Aedes albopictus and Armigera sp. were dominant in the traps, including control. Population of Aedes aegypti reported in the test traps by way of egg laying was reduced drastically by 11^{th} week. The number of adults representing the population also showed reduced number of Aedes aegypti and Culex sp. compared to Aedes albopictus and Armigera sp. The population of adults drastically reduced up to 5-acre area, as evident by adult sampling during evening hours using sweep net.

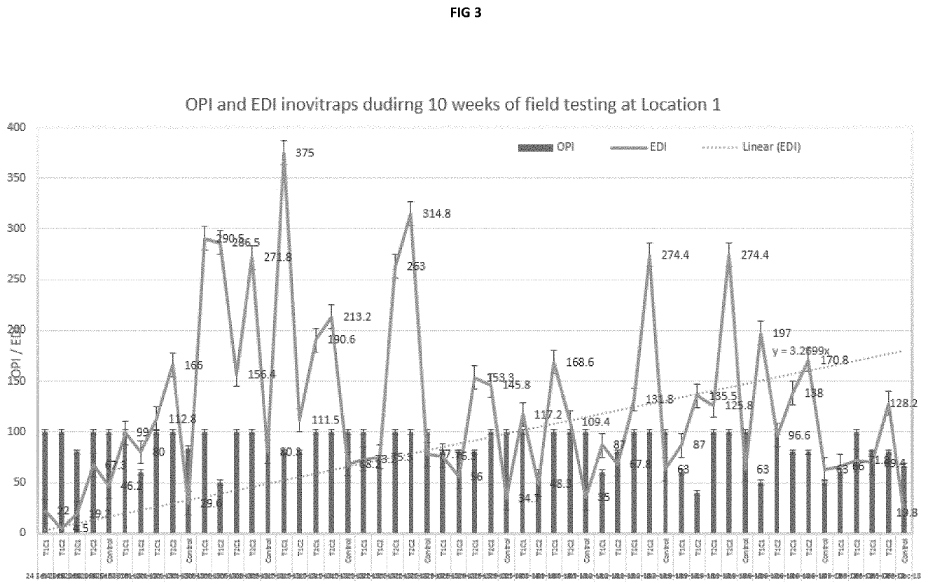

Referring to FIG. 3 all the traps including control did recorded egg laying by mosquitoes from 1^{st} week. OPI (Ovitrap Positivity Index) was 100 for treatments and above 50 for control traps throughout the study period. EDI (Egg Density Index) increased with time, showing considerable fluctuations. EDI did depict a linear stepping up (trend line) indicating a positive correlation in egg density in ovitraps with time. From the 2^{nd} week, the EDI was high in all treatments compared to control and a general trend followed. As per the data on 11^{th} week, highest EDI was obtained for T1 (200) followed by T2 (>150). The EDI for control traps was always low and fluctuated between 25-80 throughout the study until 9^{th} week. By 11^{th} week, despite OPI being >50 for all treatments and control, EDI reduced drastically. On 11^{th} week, T2, C2 recorded highest EDI of ˜120, followed by T2, C1 and lowest was in control traps. Clearly there exists a significant positive correlation between EDI and time.

### Location 2:

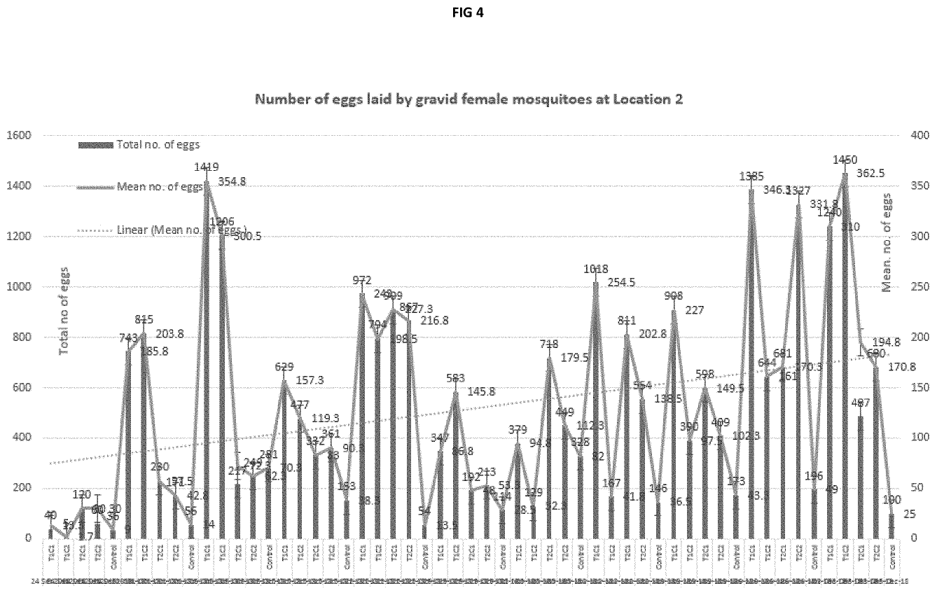

Referring to FIG. 4, egg laying, mostly by Aedes aegypti and Aedes albopictus, was noticed in control as well as treatments (T1, T2) at all concentrations. In both treatments, total number of eggs and mean number of eggs was 2-3-fold higher compared to control. Number of eggs (mean and total) increased with time in both treatments till 10^{th} week and ranged from 600-1400 and was lowest in control (<200). Total and mean number of eggs in control traps was lowest at all 10 weeks of observation. Always, mean number of eggs laid in control traps ranged between 30-300. Aedes aegypti and Aedes albopictus mosquitoes reported from first week in all the traps. Armigera sp. were attracted for oviposition from 3^{rd} week onwards. From 7^{th} week onwards, Culex quinquefasciatus also was attracted for oviposition. At 11^{th} week of the study, T1 and T2 showed increasing attractiveness to the gravid females as shown by the number of eggs. At 11^{th} week, the mean no. of eggs was >1400 in T1 and ˜500 in T2. Mean number in control traps was 100 on the 11^{th} week of the study. Both the treatments were more attractive to the gravid female mosquitoes compared to control traps all through the study. The population of adults drastically reduced up to 5-acre area as evident by adult sampling during evening hours using sweep net. The mosquito population in the area around the trap has been reduced which is attributable to the presence of traps. The presence of conditioned water in traps (T1, T2) have been highly attractive to the fecund gravid females of different genera and species. The presence of dogs is also favouring them, providing them constant hosts for blood feeding. Despite this, in an area of about 5 acres which is covered by grasses and trees, mosquito activity was not observed, even during peak hours of the evening (4.00 pm to 7.30 pm), which is undoubtedly because of the population reduction by way of deploying the ovitraps with water conditioners.

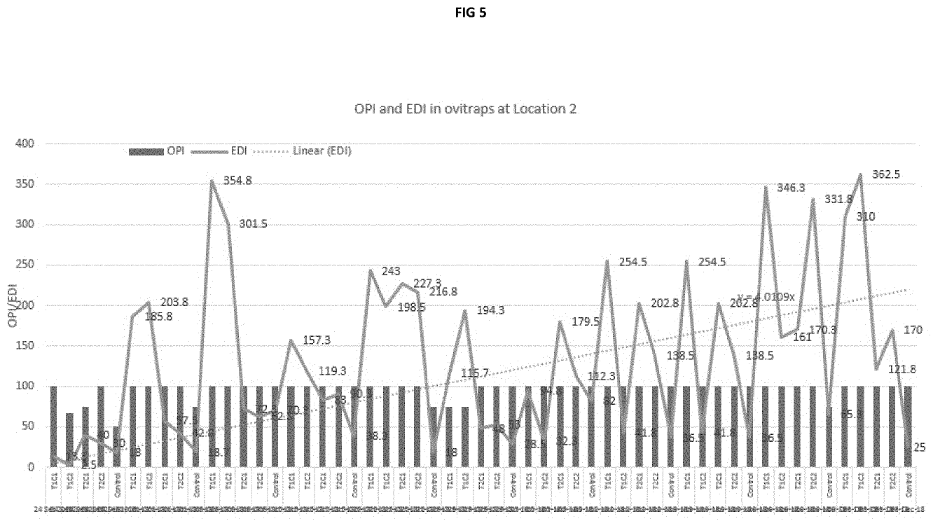

Referring to FIG. 5, OPI (Ovitrap Positivity Index) was 100 for treatments and above 50 for control traps throughout the study period. EDI (Egg Density Index) increased with time and did show a linear stepping up (trend line) indicating a positive correlation in egg density in ovitraps with time. From 2^{nd} week, the EDI was high in all treatments compared to control and the trend followed. At 11^{th} week, the EDI was highest in T1 (>300), followed by T2 (>125) and was lowest in the control (25). There exists a significant positive correlation between EDI and time. Aedes aegypti and Aedes albopictus mosquitoes reported from first week in all the traps. Armigera sp. were attracted for oviposition from 3^{rd} week onwards. From 7^{th} week onwards, Culex quinquefasciatus also was attracted for oviposition. On 11^{th} week, Armigera and Aedes albopictus were more frequently reported in the traps and incidence of Aedes aegypti was very occasional. The adult samples collected in the 5-acre area also revealed a similar pattern.

### Sequence of Mosquito Genera and Species Reporting in Universal Ovitraps:

The field trials demonstrated the use of cow urine was effective in attracting and killing a range of different species.

The range is illustrated in Table 3 below which shows weekly occurrence of different genera and species of mosquitoes reported to lay eggs in Ovitraps in test location

TABLE 3

| | | | | Mosquito genera, species | |
|---|---|---|---|---|---|
| Sl. No. | Date | Week | Treatment | (L1) | (L2) |
| 1 | 24 Sep. 2018 | Week 1 | T1C1 | Aedes sp. | Aedes sp. |
| 2 | | | T1C2 | Aedes sp. | Aedes sp. |
| 3 | | | T2C1 | Aedes sp. | Aedes sp. |
| 4 | | | T2C2 | Aedes sp. | Aedes sp. |
| 5 | | | Control | Aedes sp. | Aedes sp. |
| | | | (Water) | | |
| 6 | 1 Oct. 2018 | Week 2 | T1C1 | Aedes sp. | Aedes sp. |
| | | | | Aedes albopictus | Aedes aegypti |
| | | | | | Aedes albopictus |
| 7 | | | T1C2 | Aedes sp. | Aedes sp. |
| 8 | | | T2C1 | Aedes sp. | Aedes sp. |
| | | | | Aedes albopictus | Aedes albopictus |
| 9 | | | T2C2 | Aedes sp. | Aedes sp. |
| | | | | Aedes albopictus | |
| 10 | | | Control | Aedes sp. | Aedes sp. |
| | | | (Water) | Aedes albopictus | Aedes albopictus |
| 11 | 8 Oct. 2018 | Week 3 | T1C1 | Aedes sp. | Aedes aegypti |
| | | | | Aedes albopictus | Aedes albopictus |
| 12 | | | T1C2 | Aedes sp. | Aedes sp. |
| | | | | Aedes albopictus | Armigera sp. |
| 13 | | | T2C1 | Aedes sp. | Aedes sp. |
| | | | | Aedes albopictus | Aedes albopictus |
| 14 | | | T2C2 | Aedes sp. | Aedes aegypti |
| | | | | Aedes albopictus | Aedes albopictus |
| 15 | | | Control | Aedes sp. | Aedes sp. |
| | | | (Water) | Aedes albopictus | Aedes albopictus |
| 16 | 15 Oct. 2018 | Week 4 | T1C1 | Aedes sp. | Armigera sp. |
| | | | | Armigera sp. | Aedes albopictus |
| 17 | | | T1C2 | Aedes sp. | Armigera sp. |
| | | | | Armigera sp. | Aedes aegypti |
| | | | | Aedes aegypti | Aedes albopictus |
| | | | | Aedes albopictus | |
| 18 | | | T2C1 | Aedes sp. | Armigera sp. |
| | | | | Aedes albopictus | Aedes albopictus |
| 19 | | | T2C2 | Aedes sp. | Aedes sp. |
| | | | | Armigera sp. | Armigera sp. |
| | | | | Aedes albopictus | Aedes albopictus |
| 20 | | | Control | Aedes sp. | Aedes sp. |
| | | | (Water) | Aedes albopictus | Aedes aegypti |
| | | | | | Aedes albopictus |
| 21 | 22 Oct. 2018 | Week 5 | T1C1 | Aedes sp. | Armigera sp. |
| | | | | Armigera sp. | Aedes albopictus |
| | | | | Aedes albopictus | Aedes sp. |
| 22 | | | T1C2 | Armigera sp. | Armigera sp. |
| | | | | Aedes aegypti | Aedes albopictus |
| | | | | Aedes albopictus | Aedes sp. |
| 23 | | | T2C1 | Armigera sp. | Armigera sp. |
| | | | | Aedes aegypti | Aedes albopictus |
| | | | | Aedes albopictus | |
| | | | | Aedes sp. | |
| 24 | | | T2C2 | Aedes sp. | Aedes aegypti |
| | | | | Aedes albopictus | Aedes albopictus |
| | | | | | Aedes sp. |
| 25 | | | Control | Aedes sp. | Aedes aegypti |
| | | | (Water) | Aedes albopictus | Aedes albopictus |
| | | | | | Aedes sp. |
| 26 | 29 Oct. 2018 | Week 6 | T1C1 | Aedes albopictus | Aedes albopictus |
| | | | | Armigera sp. | Armigera sp. |
| | | | | Aedes sp. | Aedes sp. |
| 27 | | | T1C2 | Aedes albopictus | Aedes albopictus |
| | | | | Armigera sp. | Armigera sp. |
| | | | | Aedes aegypti. | Aedes sp. |
| 28 | | | T2C1 | Aedes albopictus | Aedes albopictus |
| | | | | Armigera sp. | Armigera sp. |
| | | | | Aedes aegypti | |
| | | | | Aedes sp. | |
| 29 | | | T2C2 | Aedes albopictus | Aedes albopictus |
| | | | | Aedes sp. | Aedes aegypti |
| | | | | | Aedes sp. |
| 30 | | | Control | Aedes albopictus | Aedes albopictus |
| | | | (Water) | Aedes sp. | |
| 31 | 5 Nov. 2018 | Week 7 | T1C1 | Aedes albopictus | Armigera sp. |
| | | | | Aedes aegypti | Aedes sp. |
| | | | | Aedes sp. | |
| 32 | | | T1C2 | Aedes sp. | Armigera sp. |
| | | | | | Aedes sp. |
| 33 | | | T2C1 | Aedes albopictus | Aedes albopictus |
| | | | | Aedes sp. | Aedes sp. |
| | | | | | Culex quinquefasciatus |
| 34 | | | T2C2 | Aedes albopictus | Armigera sp. |
| | | | | Aedes sp. | Aedes sp. |
| 35 | | | Control | Aedes albopictus | Armigera sp. |
| | | | (Water) | Aedes aegypti | Aedes sp. |
| | | | | Aedes sp. | |
| 36 | 12 Nov. 2018 | Week 8 | T1C1 | Aedes albopictus | Armigera sp. |
| | | | | Aedes aegypti | Aedes sp. |
| | | | | Aedes sp. | |
| 37 | | | T1C2 | Aedes sp. | Armigera sp. |
| | | | | | Aedes sp. |
| 38 | | | T2C1 | Aedes albopictus | Aedes albopictus |
| | | | | Aedes sp. | Aedes sp. |
| | | | | | Culex quinquefasciatus |
| 39 | | | T2C2 | Aedes albopictus | Armigera sp. |
| | | | | Aedes sp. | Aedes sp. |
| 40 | | | Control | Aedes albopictus | Armigera sp. |
| | | | (Water) | Aedes aegypti | Aedes sp. |
| | | | | Aedes sp. | |
| 41 | 19 Nov. 2018 | Week 9 | T1C1 | Armigera sp. | Armigera sp. |
| | | | | Aedes sp. | Aedes sp. |
| 42 | | | T1C2 | Aedes sp. | Aedes sp. |
| 43 | | | T2C1 | Aedes albopictus | Aedes albopictus |
| | | | | Aedes sp. | Aedes sp. |
| | | | | | Armigera sp. |
| 44 | | | T2C2 | Aedes albopictus | Aedes albopictus |
| | | | | Aedes sp. | Aedes sp. |
| 45 | | | Control | Aedes albopictus | Aedes albopictus |
| | | | (Water) | Aedes sp. | Aedes sp. |
| 46 | 26 Nov. 2018 | Week 10 | T1C1 | Armigera sp. | Armigera sp. |
| | | | | Aedes albopictus | Aedes sp. |
| 47 | | | T1C2 | Aedes sp. | Aedes albopictus |
| | | | | Armigera sp. | Aedes sp. |
| | | | | | Armigera sp. |
| 48 | | | T2C1 | Aedes albopictus | Aedes sp. |
| | | | | Aedes sp. | Armigera sp. |
| 49 | | | T2C2 | Aedes albopictus | Aedes aegypti |
| | | | | Aedes sp. | Aedes sp. |
| | | | | | Armigera sp. |
| 50 | | | Control | Aedes albopictus | Aedes albopictus |
| | | | (Water) | | |
| 51 | 3 Dec. 2018 | Week 11 | T1C1 | Armigera sp. | Armigera sp. |
| | | | | Aedes albopictus | Aedes sp. |
| | | | | Aedes sp. | |
| 52 | | | T1C2 | Aedes sp. | Aedes albopictus |
| | | | | Armigera sp. | Aedes sp. |
| | | | | | Armigera sp. |
| 53 | | | T2C1 | Aedes albopictus | Aedes sp. |
| | | | | Aedes sp. | Armigera sp. |
| 54 | | | T2C2 | Aedes albopictus | Aedes aegypti |
| | | | | Aedes sp. | Aedes sp. |
| | | | | | Armigera sp. |
| 55 | | | Control | Aedes albopictus | Aedes albopictus |
| | | | (Water) | | Aedes sp. |
| 56 | 10 Dec. 2018 | Week 12 | T1C1 | Armigera sp. | Aedes albopictus |
| | | | | Aedes sp. | Aedes sp. |
| | | | | | Armigera sp. |
| 57 | | | T1C2 | Aedes sp. | Aedes albopictus |
| | | | | | Aedes sp. |
| | | | | | Armigera sp. |
| 58 | | | T2C1 | Aedes albopictus | Aedes albopictus |
| | | | | Aedes sp. | Aedes sp. |
| 59 | | | T2C2 | Aedes sp. | Aedes albopictus |
| | | | | | Aedes sp. |
| | | | | | Armigera sp. |
| 60 | | | Control | Aedes albopictus | Aedes albopictus |
| | | | (Water) | Aedes sp. | Aedes sp. |
| 61 | 17 Dec. 2018 | Week 13 | T1C1 | Aedes sp. | Aedes sp. |
| | | | | Armigera sp. | |
| 62 | | | T1C2 | Aedes sp. | Aedes sp. |
| 63 | | | T2C1 | Aedes albopictus | Aedes sp. |
| | | | | Aedes sp. | |
| | | | | Armigera sp. | |
| 64 | | | T2C2 | Aedes sp. | Aedes sp. |
| 65 | | | Control | Aedes albopictus | Aedes sp. |
| | | | (Water) | Aedes sp. | |
| 66 | 24 Dec. 2018 | Week 14 | T1C1 | Aedes sp. | Aedes sp. |
| 67 | | | T1C2 | Aedes sp. | Aedes sp. |
| | | | | | Armigera sp. |
| 68 | | | T2C1 | Aedes sp. | Aedes sp. |
| | | | | Armigera sp. | |
| 69 | | | T2C2 | Aedes sp. | Aedes sp. |
| | | | | Armigera sp. | |
| 70 | | | Control | Aedes sp. | Aedes sp. |
| | | | (Water) | Armigera sp. | |
| | | | | Aedes albopictus | |
| 71 | 31 Dec. 2018 | Week 15 | T1C1 | Aedes sp. | Aedes sp. |
| | | | | | Armigera sp. |
| 72 | | | T1C2 | Aedes sp. | Aedes sp. |
| | | | | | Armigera sp. |
| 73 | | | T2C1 | Aedes sp. | Aedes sp. |
| | | | | Armigera sp. | Armigera sp. |
| 74 | | | T2C2 | Aedes sp. | Aedes sp. |
| | | | | Armigera sp. | Armigera sp. |
| 75 | | | Control | Aedes sp. | Aedes albopictus |
| | | | (Water) | Armigera sp. | Aedes sp. |
| 76 | 7 Jan. 2018 | Week 16 | T1C1 | — | Aedes sp. |
| | | | | | Armigera sp. |
| 77 | | | T1C2 | Aedes sp. | Aedes sp. |
| | | | | | Armigera sp. |
| 78 | | | T2C1 | Aedes sp. | Aedes sp. |
| | | | | | Armigera sp. |
| | | | | | Aedes albopictus |
| 79 | | | T2C2 | Aedes albopictus | Aedes sp. |
| | | | | Aedes sp. | Armigera sp. |
| 80 | | | Control | Aedes albopictus | Aedes albopictus |
| | | | (Water) | Aedes sp. | |
| 81 | 14 Jan. 2018 | Week 17 | T1C1 | — | Aedes sp |
| 82 | | | T1C2 | — | Aedes sp |
| 83 | | | T2C1 | — | Aedes albopictus |
| 84 | | | T2C2 | Aedes sp. | — |
| 85 | | | Control | Aedes albopictus | — |
| | | | (Water) | | |
| 86 | 21 Jan. 2018 | Week 18 | T1C1 | Aedes sp | Aedes albopictus |
| 87 | | | T1C2 | — | — |
| 88 | | | T2C1 | Aedes albopictus | — |
| 89 | | | T2C2 | Aedes sp | — |
| 90 | | | Control | Aedes albopictus | — |
| | | | (Water) | | |
| 91 | 29 Jan. 2018 | Week 19 | T1C1 | — | Aedes sp |
| 92 | | | T1C2 | — | — |
| 93 | | | T2C1 | Anopheles sp. | Aedes sp |
| 94 | | | T2C2 | — | — |
| 95 | | | Control | Aedes albopictus | Aedes sp |
| | | | (Water) | | |

Interestingly, the field trials conducted at both field sites, revealed a sequence in the genera and species of mosquitoes reported in the ovitraps from 1^{st} to 8^{th} week. The pattern indeed is very consistent across locations and suggests that the traps become increasingly attractive to egg laying gravid females of diverse groups of mosquitoes and continues to get significant number of eggs deposited on 8^{th} week post water conditioning.

The first species of mosquito to get attracted to the traps in both the study sites was from 1^{st} week was Aedes albopictus and Aedes aegypti. They continued to report till 9^{th} week. From the 3^{rd} week onwards, the traps also attracted a new genus of mosquitoes i.e., Armigera sp. Other significant facts emerging from our study was the traps did attract Culex quinquefasciatus mosquitoes from 7^{th} week of the initiation of the field test and this was true for both the locations. Culex quinquefasciatus is a vector of lymphatic filariasis and arboviruses including St. Louis encephalitis virus and West Nile virus. Also, Anophonles sp were detected.

### CONCLUSIONS

The CU and Tablets were both highly effective in attracting gravid females of mosquitoes for egg laying. The attractiveness was evident by higher oviposition rates in them compared to control traps during the study period. The traps attracted gravid females of Aedes aegypti, Aedes albopictus, Armigera sp., Culex quinquefasciatus and Anophonles sp as evident by identification of larvae collected from the traps. The feedback from people living in both study locations also implies reduced mosquito activity in open areas. The significant feature is that both the treatments were preferred over control for oviposition, even at 10^{th} week of the study. The effect of treatments that differentiated them form water cannot be ignored and this effect persisted even by 10^{th} week of the trial. In both locations, in an area of about 5 acres which is covered by grasses, and trees, Applicant did not find mosquito activity even during peak hours of the evening (4.00 pm to 7.30 pm), which was undoubtedly due to population reduction by way of deploying the ovitraps with water conditioners. The attractiveness of conditioned water remained effective in L2 while in L1, it reduced. The fact that the population density indices (EDI, Adult abundance) was always low in L1 compared to L2 cannot be ignored. The study clearly indicates that the cow urine and the cow urine tablets used here for water conditioning remain attractive/effective for >10 weeks, which is of great significance.

On the basis of the finding it is proposed that the methodology could replenish the ovitraps with conditioned water every 8 to 12 weeks, e.g. bimonthly or quarterly.

In summary, the experiments indicate that cow urine deployed in multiple ovitraps per acre reduced the population effectively in <10 weeks by attracting the adults to deposit their eggs in high densities and interfering with lifecycle of the vector, in effect bringing about larval and adult reduction.

1. A method of controlling mosquito populations comprising:
Placing a plurality of ovitraps into an area where it is desired to reduce a mosquito population;
Filling the ovitraps with water;
Introducing a defined larvicidal amount of a water conditioning agent comprising cow urine into a given volume of water into the ovitraps to condition the water absent of a separate or additional pesticide;
Leaving the conditioned water for at least 7 weeks; and
Monitoring at least one of the ovitrap and the area to determine effectiveness.

2. A method as claimed in claim 1, wherein the cow urine is derived from Bos indicus or Zebu cattle.

3. A method as claimed in claim 1, wherein the mosquito population targeted is from the subfamily Anophelinae.

4. A method as claimed in claim 1, wherein the mosquito population targeted is from the subfamily Culicinae.

5. A method as claimed in claim 3, wherein the mosquito population targeted is from the genus Anopheles and is configured to control human malaria.

6. A method as claimed in claim 4, wherein the mosquito population targeted is from the genus Culicine and is configured to control yellow fever or Dengue fever.

7. A method as claimed in claim 1, wherein the monitoring further comprises at least one of monitoring adult mosquito numbers, monitoring a number of eggs deposited, and determining a number of dead larvae.

8. A method as claimed in claim 1, further comprising deploying a plurality ovitraps per acre.

9-17. (canceled)

18. A method as claimed in claim 2, wherein the monitoring further comprises monitoring adult mosquito numbers.

19. A method as claimed in claim 2, wherein the monitoring further comprises monitoring a number of eggs deposited.

20. A method as claimed in claim 2, wherein the monitoring further comprises determining a number of dead larvae.

21. A method as claimed in claim 2, wherein the monitoring further comprises monitoring adult mosquito numbers, monitoring a number of eggs deposited, and determining a number of dead larvae.

22. A method as claimed in claim 3, wherein the cow urine is derived from Bos indicus.

23. A method as claimed in claim 3, wherein the cow urine is derived from Zebu cattle.

24. A method as claimed in claim 4, wherein the cow urine is derived from Bos indicus.

25. A method as claimed in claim 4, wherein the cow urine is derived from Zebu cattle.

26. A method of controlling mosquito populations comprising:
Placing a plurality of ovitraps into an area where it is desired to reduce a mosquito population;
Filling the ovitraps with water;
Conditioning the water by introducing a defined larvicidal amount of a water conditioning agent comprising cow urine into a given volume of water into the ovitraps, wherein the water is absent of a separate or additional pesticide;
Leaving the conditioned water for at least 7 weeks; and
Monitoring the ovitrap to determine effectiveness after leaving the conditioned water for at least 7 weeks.

27. A method as claimed in claim 26, wherein the cow urine is derived from Bos indicus.

28. A method as claimed in claim 26, wherein the cow urine is derived from Zebu cattle.

29. A method as claimed in claim 26, wherein the monitoring further comprises at least one of monitoring adult mosquito numbers, monitoring a number of eggs deposited, and determining a number of dead larvae.
